(19) United States
(12) Patent Application Publication
(10) Pub. No.: US 2010/0045606 A1
(43) Pub. Date: Feb. 25, 2010

(54) PORTABLE COMPUTER

(75) Inventors: Chi-Yi Liu, Taipei (TW); Yu-Chuan Shen, Taipei (TW); Jih-Hung Huang, Taipei (TW); Wen-Chou Liu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/472,381

(22) Filed: May 27, 2009

(30) Foreign Application Priority Data
Aug. 22, 2008 (TW) 97132238

(51) Int. Cl. G06F 3/02; G06F 3/041

(52) U.S. Cl. 345/168; 345/173

(57) ABSTRACT

A portable computer including a host and an input device is provided. The host has a accommodating space and a first wireless transmission unit. The input device is detachably disposed in the accommodating space and has a touch pad, a plurality of control buttons and a second wireless transmission unit. The touch pad and the control buttons are electrically connected to the second wireless transmission unit. The second wireless transmission unit is used for performing wireless transmission with the first wireless transmission unit.

### CROSS-REFERENCE TO RELATED APPLICATION

This application claims the priority benefit of Taiwan application serial no. 97132238, filed Aug. 22, 2008. The entirety of the above-mentioned patent application is hereby incorporated by reference herein and made a part of specification.

### BACKGROUND OF THE INVENTION

1. Field of the Invention

The present invention relates to a computer. More particularly, the present invention relates to a portable computer.

2. Description of Related Art

In a current information age, people increasingly depend on electronic products. Computers and video-audio products are all over around, and the electronic products become indispensable in our daily life. Moreover, with development of electronic technology and demand of high speed, high efficiency, light and slim, pluralism and better functions, etc. for the electronic products, portable electronic products, such as notebook computers become popular. In the past, the notebook computers are only for business usage. However, as performance of the notebook computers increases, they gradually substitute desktop computers to serve as office-use computers, even many consumers start to use the notebook computer as an entertainment device to watch movies, enjoy music, play computer games or online games.

However, a conventional portable computer only has a touch pad and two function keys to implement a mouse function. If a user wants to use the portable computer to play a game, to facilitate operations, an external joystick is generally purchased, additionally. When the user plays the game, he has to connect the joystick to the portable computer first, and after the utilization, he has to disassemble the joystick from the portable computer. Therefore, for the user, such design is complicated and inconvenient.

### SUMMARY OF THE INVENTION

The present invention is directed to a portable computer, which may improve a usage convenience when a user uses the portable computer to play a game.

The present invention provides a portable computer comprising a host and an input device. The host has a accommodating space and a first wireless transmission unit. The input device is detachably disposed in the accommodating space and has a touch pad, a plurality of control buttons and a second wireless transmission unit. The touch pad and the control buttons are electrically connected to the second wireless transmission unit. The second wireless transmission unit is used for performing wireless transmission with the first wireless transmission unit.

In an embodiment of the present invention, the host includes a base and a display device. The base has the accommodating space, and the display device is pivotally connected to the base.

In an embodiment of the present invention, the input device includes a first part and two second parts. The first part has a first surface and an opposite second surface. The touch pad is located on the first surface, and the control buttons are disposed on the second surface. The second parts are pivotally connected to the first part, and are suitable for being rotated to close to or depart from each other

In an embodiment of the present invention, the control buttons include a direction key, a plurality of function keys and a plurality of setting keys.

In an embodiment of the present invention, the first wireless transmission unit and the second wireless transmission unit form a module, and the module is a bluetooth module or an infrared module.

In an embodiment of the present invention, the host further has a withdraw device disposed aside the accommodating space, which is used for withdrawing the input device form the accommodating space.

In an embodiment of the present invention, the host further has a plurality of first contacts exposed in the accommodating space. The input device further has a plurality of second contacts corresponding to the first contacts.

In an embodiment of the present invention, the host further has a non-contact charging module for charging the input device.

In an embodiment of the present invention, a bottom surface of the accommodating space has a plurality of concave areas for accommodating the control buttons.

In an embodiment of the present invention, the input device further has a plurality of function keys.

In the portable computer of the present invention, since the input device is detachable, and can communicate with the host via wireless transmission, and the control buttons are integrated to the input device, the user can play the game without assembling an external joystick. Therefore, utilization of the portable computer can be convenient.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded diagram of a portable computer according to an embodiment of the present invention.

FIG. 2 is another view of an input device of FIG. 1 with two second parts mutually departed.

### DESCRIPTION OF EMBODIMENTS

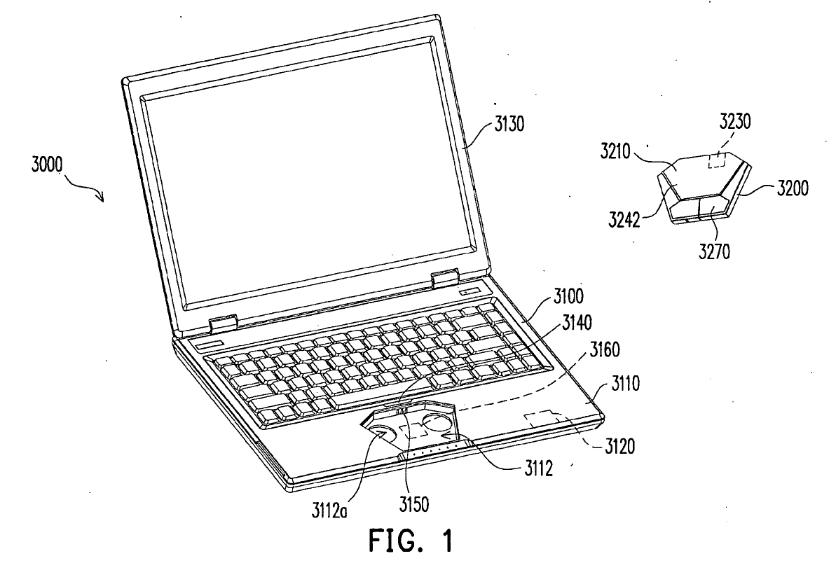

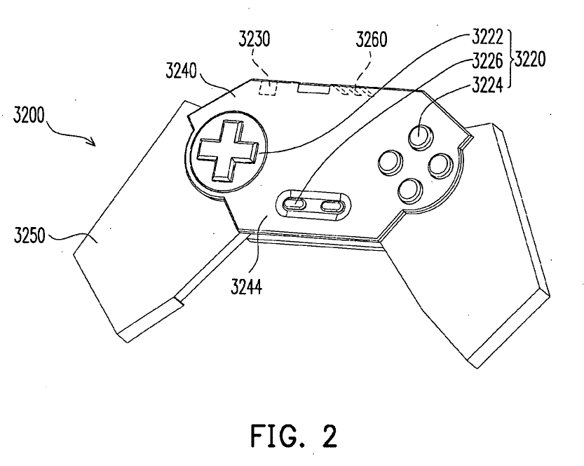

FIG. 1 is an exploded diagram of a portable computer according to an embodiment of the present invention. FIG. 2 is another view of the input device of FIG. 1 with two second parts mutually departed. Referring to FIG. 1 and FIG. 2, the portable computer 3000 includes a host 3100 and an input device 3200. The host 3100 has a accommodating space 3112 and a first wireless transmission unit 3120. The first wireless transmission unit 3120 is, for example, disposed in a housing of the host 3 100. The input device 3200 is detachably disposed in the accommodating space 3112, and has a touch pad 3210, a plurality of control buttons 3220 and a second wireless transmission unit 3230. The touch pad 3210 and the control buttons 3220 are, for example, respectively disposed on corresponding surfaces of the input device 3200. The touch pad 3210 and the control buttons 3220 are electrically connected to the second wireless transmission unit 3230. The second wireless transmission unit 3230 is used for performing wireless transmission with the first wireless transmission unit 3120.

Referring to FIG. 1 again, when a user operates the input device 3200 to play a game or other programs, input signals generated by the input device 3200 are transmitted to the first wireless transmission unit 3120 by the second wireless transmission unit 3230. By such means, the host 3100 can generates working commands according to the received signals. In the present embodiment, the first wireless transmission unit 3120 serves as a signal receiving end, and the second wireless transmission unit 3230 severs as a signal transmitting end. Certainly, the first wireless transmission unit 3120 can also serve as the signal transmitting end, and the second wireless transmission unit 3230 can also sever as the signal receiving end. The first wireless transmission unit 3120 and the second wireless transmission unit 3230 form a module, and the module can be a bluetooth module, an infrared module or other wireless transmission modules.

Particularly, since the user operates the game by directly pressing the control buttons 3220 on the input device 3200, the user can enjoy a control sense as that of using a general joystick. Namely, purchasing of an additional joystick is unnecessary, and plug/unplug operations of the joystick are avoided, which not only saves money, but also has an excellent convenience. On the other hand, since the touch pad 3210 and the control buttons 3220 are integrated to the input device 3200, number of accessories of the portable computer 3000 can be reduced. When the input device 3200 is not used, it can be disposed in the accommodating space 3112 to prevent losing the input device 3200. Moreover, according to a design of the wireless transmission, a distance between the user and the host 3100 can be increased, so as to protect eyesight of the user.

In the present embodiment, the host 3100 of the portable computer 3000 includes a base 3110, a display device 3130 and a withdraw device 3140. The accommodating space 3112 is disposed on the base 3110, and a bottom surface of the accommodating space 3112 has a plurality of concave areas 3112a. When the input device 3200 is disposed in the accommodating space 3112, the touch pad 3210 is exposed outside the base 3110, and the control buttons 3220 are accommodated into the concave areas 3112a. The display device 3130 is pivotally connected to the base 3110, so that the display device 3130 can be opened and closed relative to the base 3110. However, the portable computer 3000 can also apply a flat panel design. Namely, the host 3100 is not limited to be divided into the pivotally connected base 3110 and the display device 3130. Certainly, in other designs, the host 3100 can be divided into more parts.

The withdraw device 3140 is disposed aside the accommodating space 3112 for withdrawing the input device 3200 from the accommodating space 3112. In the present embodiment, the withdraw device 3140 for example has a press design. When the user is about to fetch the input device 3200, he may just press the withdraw device 3140, and the withdraw device 3140 can prop up the input device 3200 from the accommodating space 3112, which is quick and convenient. Certainly, the withdraw device 3140 can also have other suitable designs which are not described herein. Alternatively, a notch (not shown) can be maintained around the accommodating space 3112, so that the user can directly fetch the input device 3200 via the notch.

Moreover, the host 3100 also has a plurality of first contacts 3150 disposed in the accommodating space 3112, and the input device 3200 has a plurality of second contacts 3260 corresponding to the first contacts 3150. When the user disposes the input device 3200 into the accommodating space 3112, the first contacts 3150 in the accommodating space 3112 contact the second contacts 3260 on the input device 3200. Now, the host 3100 can supply power to the input device 3200 for charging the input device 3200. Charging the input device 3200 by using the host 3100 can save a cost of purchasing an external charger, which can both save the power and the money.

Selectively, the host 3100 can also have a non-contact charging module 3160 for charging the input device 3200. By applying the non-contact charging module 3160, no contact is required to be allocated on the host 3100, and the input device 3200 can be directly charged by just putting the input device 3200 into the accommodating space 3112. In the present embodiment, the non-contact charging module 3160 is, for example, an electromagnetic induction-type non-contact charging module, which applies electromagnetic induction and power conversion techniques to implement the charging. By applying the non-contact charging module 3160 to perform the charging, problems caused by poor contact of the terminals can be avoided. Though in the present embodiment, the host 3100 can perform the contact charging or the non-contact charging to the input device 3200, only one of the two charging methods is required to be selected and applied to the portable computer 3000, or the input device 3200 can be charged via the external charger (not shown).

In detail, the input device 3200 further includes a first part 3240 and two second parts 3250. The first part 3240 has a first surface 3242 and an opposite second surface 3244, wherein the touch pad 3210 is located on the first surface 3242, and the control buttons are located on the second surface 3244. The second parts 3250 are pivotally connected to two side edges of the first part 3240, respectively, and the second parts 3250 are suitable for being rotated to close to or depart from each other. In FIG. 1, the second parts 3250 are closed together, and in FIG. 2, the second parts 3250 are separated from each other.

When the user uses the input device 3200 to play the game, the two second parts 3250 can be rotated outwards as that shown in FIG. 2, which can meet a design of human-factors engineering, so that the user may have a comfortable usage sense when holding the input device 3200. After the utilization, the two parts 3250 can be rotated inwards as that shown in FIG. 1, so as to reduce an area of the input device 3200 and reduce an occupation area of the input device 3200 on the host 3100.

The control buttons 3220 include a direction key 3222, a plurality of function keys 3224 and a plurality of setting keys 3226. The direction key 3222 is used for controlling directions. When the user presses the direction key 3222, a corresponding control signal is generated for controlling a moving direction of a main object of the computer game. The function keys 3224 are, for example, four keys arranged up and down, left and right. When the user presses one of the function keys 3224, a control signal is generated and transmitted to the host 3100 for executing a specific function corresponding to the function key 3224, for example, jumping, attacking, menu switching, accelerating, etc. The setting keys 3226 are, for example, setting keys corresponding to setting functions of the game. For example, when the user presses one of the setting keys 3226, a control signal is generated to control pausing or starting of the game.

Moreover, the input device 3200 further has a plurality of function keys 3270, and the touch pad 3210 and the function keys 3270 are, for example, located at a same side of the input device 3200. In the present embodiment, the function keys 3270 may correspond to the left and right keys of a general mouse.

The aforementioned described functions and locations of the control buttons 3220 are not used for limiting the present invention, and the functions of the control buttons 3220 can also be determined by the user himself, and the locations of the control buttons 3220 can also be suitably changed.

As described above, though a pattern of the input device 3200 including the touch pad 3210 and the game joystick is described, music playing or other functions can be extra combined to the input device 3200. Namely, the host 3100 can be remotely controlled by the control buttons 3220 to execute an operation of playing music.

In summary, in the portable computer of the present invention, the input device having a wireless transmission design is integrated with the touch pad and the game control accessories, and the host has a space for containing the input device. Therefore, assembling of the external joystick upon the portable computer of the present invention is unnecessary, which is convenient for utilization. Moreover, the host can be used to directly charge the input device, so that purchasing of the external charger is unnecessary, and meanwhile the usage convenience is improved. In addition, the input device is suitable for being spread out, so as to meet a design of human-factors engineering, by which both of the practicality and the comfortability are satisfied.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable computer, comprising:
a host, having a accommodating space and a first wireless transmission unit; and
an input device, detachably disposed in the accommodating space, and having a touch pad, a plurality of control buttons and a second wireless transmission unit, wherein the touch pad and the control buttons are electrically connected to the second wireless transmission unit, and the second wireless transmission unit is used for performing wireless transmission with the first wireless transmission unit.

2. The portable computer as claimed in claim 1, wherein the host comprises:
a base, having the accommodating space; and
a display device, pivotally connected to the base.

3. The portable computer as claimed in claim 1, wherein the input device comprises:
a first part, having a first surface and a second surface, wherein the touch pad is located on the first surface, and the control buttons are located on the second surface; and
two second parts, pivotally connected to the first part, and suitable for being rotated to close to or depart from each other.

4. The portable computer as claimed in claim 1, wherein the control buttons comprise a direction key, a plurality of function keys and a plurality of setting keys.

5. The portable computer as claimed in claim 1, wherein the first wireless transmission unit and the second wireless transmission unit form a module, and the module is a bluetooth module or an infrared module.

6. The portable computer as claimed in claim 1, wherein the host further has a withdraw device disposed aside the accommodating space, which is used for withdrawing the input device form the accommodating space.

7. The portable computer as claimed in claim 1, wherein the host further has a plurality of first contacts exposed in the accommodating space, and the input device further has a plurality of second contacts corresponding to the first contacts.

8. The portable computer as claimed in claim 1, wherein the host further has a non-contact charging module for charging the input device.

9. The portable computer as claimed in claim 1, wherein a bottom surface of the accommodating space has a plurality of concave areas for accommodating the control buttons.

10. The portable computer as claimed in claim 1, wherein the input device further has a plurality of function keys.
